(19) United States
(12) Patent Application Publication
(10) Pub. No.: US 2014/0158639 A1
(43) Pub. Date: Jun. 12, 2014

(54) WATER STABILIZATION AND REVITALIZATION

(71) Applicant: WATER STABILIZATION AND REVITALIZATION, Laguna Woods, CA (US)

(72) Inventor: Glen B. Caulkins, Laguna Woods, CA (US)

(21) Appl. No.: 13/930,298

(22) Filed: Jun. 28, 2013

Related U.S. Application Data
(63) Continuation-in-part of application No. 13/712,581, filed on Dec. 12, 2012.

(51) Int. Cl. C02F 1/68; C02F 1/74

(52) U.S. Cl. CPC C02F 1/68; C02F 1/74
USPC 210/758; 210/749; 210/766

(57) ABSTRACT

A method of inhibiting water from ionizing and reacting with carbon dioxide includes: providing processed water having a potential for reacting H₂O with CO₂ in a system substantially devoid of O₂ and/or CO₂; providing at least about 20 PPM of negative ions to the H₂O in a sufficient amount to react therein in the system substantially devoid of O₂ and/or CO₂; and inhibiting the H₂O from reacting with CO₂ to form carbonic acid by reacting the H₂O with the negative ions in a sufficient amount in the system substantially devoid of O₂ and/or CO₂ so as to stabilize the processed water to form stabilized water. Obtaining chilled water and vortexing the chilled water over lodestones with or without aeration.

### CROSS-REFERENCE TO RELATED APPLICATIONS

This patent application is a continuation-in-part of U.S. patent application Ser. No. 13/712,581 filed Dec. 12, 2012, which patent application is incorporated herein by specific reference in its entirety.

### BACKGROUND

Although there are various hydration options, some consumers prefer drinking, bathing, and swimming in uncontaminated pristine water. Furthermore, water is frequently used in food preparation and can be an essential ingredient in a meal. There are several common sources for water, and many sources for polluting water. For example, air pollution can cause water pollution. Tap water is chemically treated with a variety of products that can include chlorine, chloramine (e.g., ammonia with chlorine), soluble silicates, aluminum sulfate, phosphate, polymers, hydrated lime, potassium permanganate, and many other chemicals. The addition of any kind of chlorine to water creates hydrochloric acid and hypochlorous acid. Chloramine eats through plumbing parts, especially toilet floats, rubber, elastomer, copper and brass pipe fittings and water heater parts. When chloramine combines with hydrofluorosilicic acid in water, it becomes so corrosive, that it deteriorates water pipes and will extract lead from plumbing systems.

Often, water is polluted before in comes in contact with contaminates found in our environment (e.g., contaminates in the ground). For example, water can be drawn from an aquifer; however, the aquifer can be contaminated from the pesticides sprayed onto the earth and from acid rain (e.g., sulfuric and nitric acids) that has contaminated the water table. In some instances, acquiring water from the aquifer may require a well and related pumping and, at times, filtration equipment. Conversely, at locations where an aquifer intersects the ground surface, rising clean or contaminated spring water may be acquired at the surface level.

As water (e.g., acidic water) enters and/or passes through the aquifer, various minerals can be exponentially dissolved in the water, which can make hard water that can affect the taste, smell, and other qualities of the water. Thus, for instance, depending on the location of the aquifer, absent filtration and conditioning, the water drawn from one aquifer may have a different taste than the water drawn from another aquifer. Additionally, in some instances hard water can cause serious health problems for consumers.

In rural areas, consumers frequently draw their water directly from an aquifer, which may be available near their dwellings or places of business. Drawing water directly from an aquifer is relatively uncommon for consumers in urban settings. Typically, urban consumers can obtain drinking water from a supplier or can use tap or municipal water, which has been treated with a host of chemicals from municipal water treatment plants (which at times may be filtered or otherwise treated by the consumer).

Whether obtained directly from an aquifer or from a municipality, the water may have various substances that can make the water unpleasant and/or dangerous or unsuitable for consumption. For example, well or aquifer water can contain various dangerous acids, inorganic minerals, pesticides, contaminants, and/or microorganisms. By contrast, municipal water, although less likely to contain microorganisms that may be found in the aquifer, typically includes chemicals used by the municipality for treating the water before distribution. For instance, municipalities often add chlorine, chloramine, hydrofluorosilicic acid (e.g., industrial grade fluoride), etc. to the water. Although some people think chemical treatment of the water may be beneficial, the chemicals used to treat the water have a negative effect on our health.

There are a number of ways tap water is usually filtered to remove excess minerals, disinfection byproducts, fluoride, chemicals, pharmaceuticals, or the like to provide the consumer with drinking water that has an improved taste. Normally, however, such filtration removes some or most of the beneficial minerals from the water. Furthermore, the filtration may not remove the acids (e.g., carbonic, sulfuric, nitric, hydrofluorosilicic, hydrochloric, hypochlorous acids, etc.), properly mineralize, restructure, and reenergize the water. Moreover, filtered and treated acidic water without proper bicarbonate salts may not have the taste or smell of contaminated water, which may be desirable by some consumers; however, such water may not be conducive to good health.

Accordingly, it would be advantageous to have methods and systems for producing pristine water.

### SUMMARY

In one embodiment, the present invention includes a method of inhibiting water from ionizing and reacting with carbon dioxide, the method comprising: providing processed water having a potential for reacting H₂O with CO₂ in a system substantially devoid of air and/or CO₂; providing at least about 20 PPM of negative ions to the H₂O in a sufficient amount to react therein in the system substantially devoid of air and/or CO₂; and inhibiting the H₂O from reacting with CO₂ to form carbonic acid by reacting the H₂O with the negative ions in a sufficient amount in the system substantially devoid of air and/or CO₂ so as to stabilize the processed water to form stabilized water. In one aspect, the processed water is processed to be acid free and/or deionized water. In one aspect, the negative ions are of calcium, magnesium, potassium, or sodium. In one aspect, the negative ions include bicarbonate ions and/or hydroxide ions. In one aspect, the bicarbonate ions and/or hydroxide ions combine with insoluble metals of hydroxides of calcium, magnesium, potassium, or sodium in the processed water to form water-soluble metal bicarbonates amounts in the system substantially devoid of air and/or CO₂. In one aspect, the water-soluble metal bicarbonates are retained in solution with a sufficient amount of bicarbonate salts, the bicarbonate salts being sufficient to prevent self-ionization. In one aspect, the negative ions are of calcium hydroxide, magnesium hydroxide, potassium bicarbonate, or sodium bicarbonate, which are provided in a sufficient amount to inhibit formation of carbonic acid. In one aspect, comprising exposing the H₂O to air and/or CO₂, wherein the H₂O is inhibited from reacting with the CO₂ to form carbonic acid. In one aspect, comprising maintaining the pH of the processed water with a sufficient amount of the negative ions. In one aspect, wherein the negative ions are magnesium ions.

In one aspect, the method includes: obtaining the stabilized water and chilling the stabilized water to about 4 degrees Celsius. In one aspect, the method includes: obtaining the chilled water and vortexing the chilled water over lodestones. In one aspect, the vortexing is sufficient to increase coherency and/or surface tension of the chilled water compared to coherency and/or surface tension before chilling and vortexing. In one aspect, the method includes: vortexing and aerating, simultaneously, the chilled water over lodestones sufficient to increase coherency and/or surface tension of the chilled water compared to coherency and/or surface tension before vortexing and aerating. In one aspect, the vortexing and aerating is performed by a mechanical recirculation pump operably coupled to a vortexing vessel having the chilled water. In one aspect, the vortexing is as follows: lodestone present from 1 ounce to 50 pounds; flow rate for the chilled water of 3 gallons per minute to 25 gallons per minute; or a vortexing vessel having between 2 gallons and 300 gallons of the chilled water being vortexed and aerated. In one aspect, the air provided during the aerating is oxygenated air or de-nitrogenated. In one aspect, the air provided during the aeration is provided through a vacuum line fluidly coupled with a recirculation line fluidly coupled with the mechanical recirculation pump. In one aspect, comprising oxygenating and air sparging the chilled water being vortexed over lodestones. In one aspect, the method includes: oxygenating and air sparging the chilled water being vortexed over lodestones to oxygenate the air sufficiently to inhibit microbe growth once the water is stored.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIGS. 1A-1E illustrate embodiments of systems for preparing revitalized water.

FIG. 2 illustrates an embodiment of a water stabilization system.

FIG. 3 illustrates an embodiment of a water chilling system.

FIG. 4 illustrates an embodiment of a water vortexing system.

FIG. 5 illustrates an embodiment of a water vortexing and aeration system.

FIG. 6 illustrates an embodiment of a water stabilization and chilling and vortexing and aeration system.

FIG. 7 illustrates a data chart and graph showing a proper pH response to a lemon challenge test.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present invention provides systems and methods for producing pristine water. The pristine water can be obtained by the process described herein, which includes stabilizing water (e.g., filtered and/or purified water) and stabilizing and brewing (e.g., brewing includes at least chilling, vortexing, and recirculating the water over lodestones). The pristine water can be referred to as revitalized water because the processes revitalize water to be pristine water. The water can be filtered and/or purified as obtained by the processes of U.S. patent application Ser. No. 13/712,581, and then stabilized and/or brewed. Unless specifically identified by the filtering and/or purification processing, the water used in the present invention can be filtered and/or purified, and reference to one can indicate that the water is processed in accordance with filtering and/or purification. In some instance, the water may be merely passed through a filter. In other instances, the water can be purified by the treatments of U.S. patent application Ser. No. 13/712,581. In addition to the specific processing described herein, the water may also be subject to the processing with the equipment of U.S. patent application Ser. No. 13/712,581, including, but not limited to: purified; degassed; removal of solids; deionized; mineralized; filtered; UV treated; descaled; reverse osmosis; cooled; carbon dioxidized; carbonic acidified; oxygenated; vortexed; or the like. Such processing can be performed before the stabilization and brewing described herein; however, processing, such as UV treatment, can be done with the stabilizing or brewing. The oxidation, carbon dioxidation, and carbonic acidification can be performed during brewing as described herein. The systems can also include the various sensors of U.S. patent application Ser. No. 13/712,581 in order to analyze the water, and then using computerized control, modulate the processing to obtain pristine or revitalized water with desired properties, such as properties described herein as being the water product. Accordingly, computerized control systems can be operably coupled with the systems and devices described herein, which can control the processing.

In one aspect, the water product can be stabilized deionized water with alkaline ions, which stops the water from self-ionizing itself with carbon dioxide. This inhibits the water from having carbonic acid. The process of stabilization can inject calcium and magnesium hydroxide and sodium and potassium bicarbonates into the water to increase the parts per million, which is conducted prior to the water coming in contact with air, which contains carbon dioxide. This will stop the water from self-ionizing. The stabilization process is performed in the absence of air, oxygen, or carbon dioxide.

In one aspect, the water product can be deionized water stabilized with magnesium ions to stop the water from ionizing itself with carbon dioxide. The process of stabilization can inject magnesium ions (e.g., negative ions) into the water, which is conducted prior to the water coming in contact with air, which contains carbon dioxide. This will stop the water from self-ionizing. The stabilization process is performed in the absence of air, oxygen, or carbon dioxide. The magnesium ions are injected by circulating the water through an additional magnesium oxide cartridge to increase the parts per million.

In one aspect, the stabilized water can be brewed by chilling and vortexing acid-free alkaline water over lodestones and crystals to erase trauma recording and to reprogram the water, which reprogramming enhances surface tension and increases the coherency of water molecules to produce revitalized water.

In one aspect, the water product can be stabilized, deionized water with alkaline ions prior to brewing in order to stop the water from ionizing itself with carbon dioxide. The stabilization process injects calcium, magnesium hydroxide, sodium, and potassium bicarbonates into the water to increase the parts per million, which stabilization process is conducted prior to the water coming in contact with air, which contains carbon dioxide. This will stop the water from self-ionizing.

In one aspect, the water product can be stabilized, deionized water with magnesium ions prior to brewing to stop the water from ionizing itself with carbon dioxide. This can include adding magnesium ions (e.g., negative ions) to the deionized water or other water prior to the water coming in contact with air, which contains carbon dioxide. This will stop the water from self-ionizing. The water is stabilized by circulating the water through a magnesium oxide cartridge in a water filter housing in the water brewing process to increase the parts per million.

In one aspect, brewing stabilized acid-free alkaline water with air that contains carbon dioxide can create carbonic acid in the alkaline water, which dissociates into bicarbonate ions.

In one embodiment, brewing acid-free water that contains sodium, potassium bicarbonate, calcium, and magnesium hydroxide with air that contains carbon dioxide can create carbonic acid in the alkaline water, which dissociates into bicarbonate ions to create sodium bicarbonate, potassium bicarbonate, calcium bicarbonate, and magnesium bicarbonate.

In one embodiment, the water (e.g., deionized water) can be stabilized by adding ElectrolyteBalance™ (e.g., sodium, potassium, calcium, and magnesium bicarbonate with or without water) to increase the PPM or the buffering capacity of the water, which helps to neutralize excess acids in the body.

Implementations of the present invention provide systems, methods, and apparatus for processing filtered water, stock water (e.g., tap water, well water, spring water, etc.), and deionized water in order to produce pristine drinking, bathing, and swimming water. This can include revitalized water. More specifically, such systems, methods, and apparatus can produce purified water by removing substantially all acids, suspended as well as dissolved solids and gasses, from the stock water. Thus, the purification treatment process can produce substantially pure water. The substantially pure water can have various uses, such as in laboratories and in various assays, or the like. The substantially pure water can then be stabilized and brewed to produce pristine or revitalized water.

After the purification process, the purified water can be properly mineralized and structured before consumption by the stabilization and brewing protocols. After the stock water is purified and substantially all of the acids, gasses, and particulate and dissolved solids have been removed, the purified water may have no significantly discernible taste and it lacks all of the beneficial minerals that may be present before purification. This purified water, however, can be useful in biological and chemical experiments, such as use as a pure water chemical reagent for a chemical reaction. Accordingly, in one embodiment, the system and method can reintroduce particularly desirable minerals into the purified water by stabilization and then brewing. Thus, the system and methods can produce high biophoton re-mineralized drinking water that can have desirable palatability as well as health-promoting qualities. As used herein, the term “drinking water” generally refers to water that has been properly processed and is ready for consumption.

In one embodiment, the substantially pure water may be further processed so as to be stabilized, mineralized, structured, and/or reenergized prior to consumption. At least one embodiment includes a water purification system for purifying working water, and then the stabilization and brewing can be performed.

Moreover, in some embodiments, introduction and/or reintroduction of a blend of minerals into the purified water (i.e., mineralization or re-mineralization) can produce taste and other beneficial qualities of the mineralized water found in nature. Thus, for example, the system and method can introduce the minerals in a manner that produces drinking water that has a taste similar to natural spring water. Furthermore, such taste can be consistently replicated by the system and method. At the same time, as noted above, the system can remove harmful and/or undesirable particulates, liquids, and/or gasses from the stock water. Consequently, the system and method can produce drinking water that contains an optimized amount of beneficial bicarbonate salts, minerals, and elements, while being substantially free of all other (e.g., non-beneficial and/or harmful) substances.

Another embodiment includes a system method of purifying, conditioning, and re-mineralizing a working water to create a high biophoton mineralized water. The high biophoton mineralized water can be obtained from the stabilized water and the stabilized and brewed water. The high biophoton mineralized water can be the pristine water or revitalized water obtained with the following systems and processes.

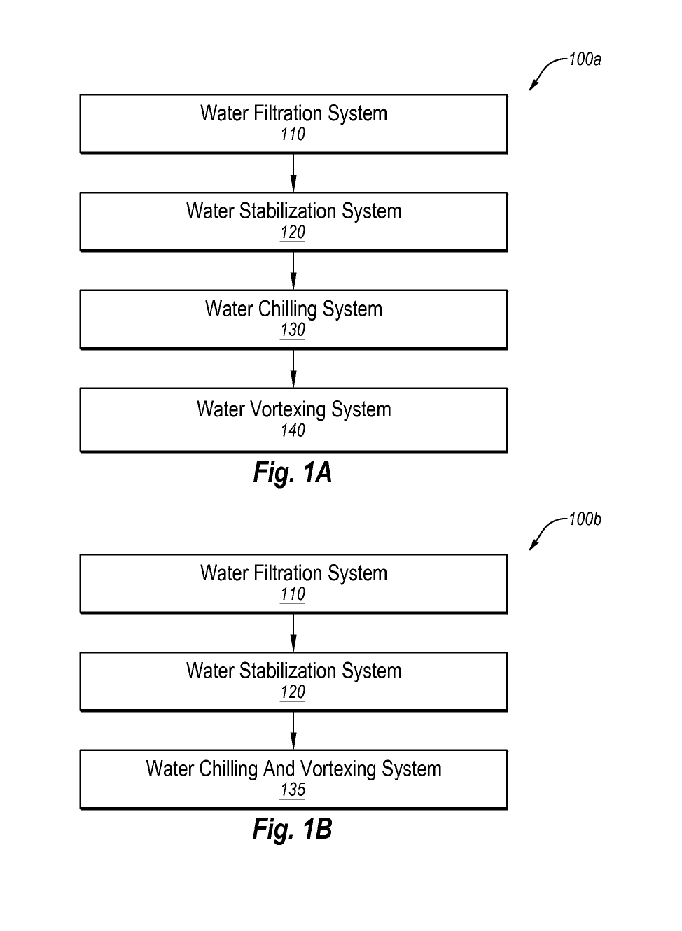

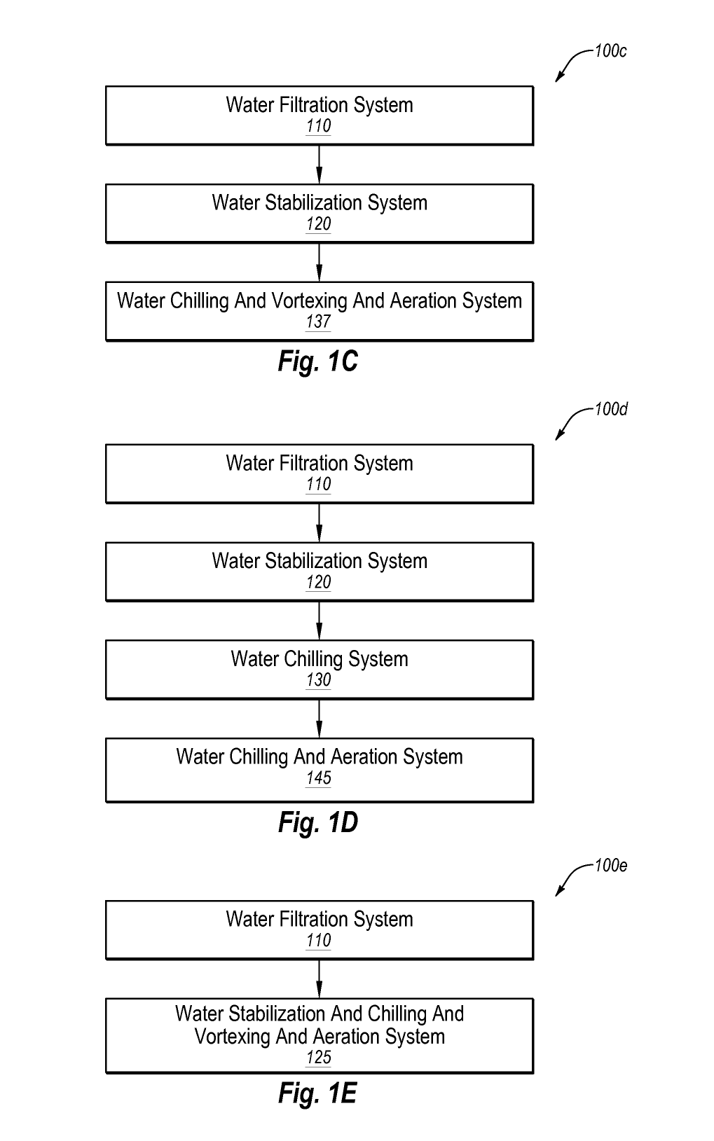

FIG. 1A illustrates a water revitalization system 100a in accordance with the present invention. The water revitalization system 100a is shown to include a water filtration system 110 that provides filtered water to a water stabilization system 120. The water filtration system 110 can be any water filtration system, or the water filtration system or water purification system described in U.S. patent application Ser. No. 13/712,581 filed Dec. 12, 2012, which is incorporated herein by specific reference. However, in any of the embodiments of the invention, the water filtration system 110 or water filtration protocol can be omitted, and filtered water can be obtained as pre-filtered water.

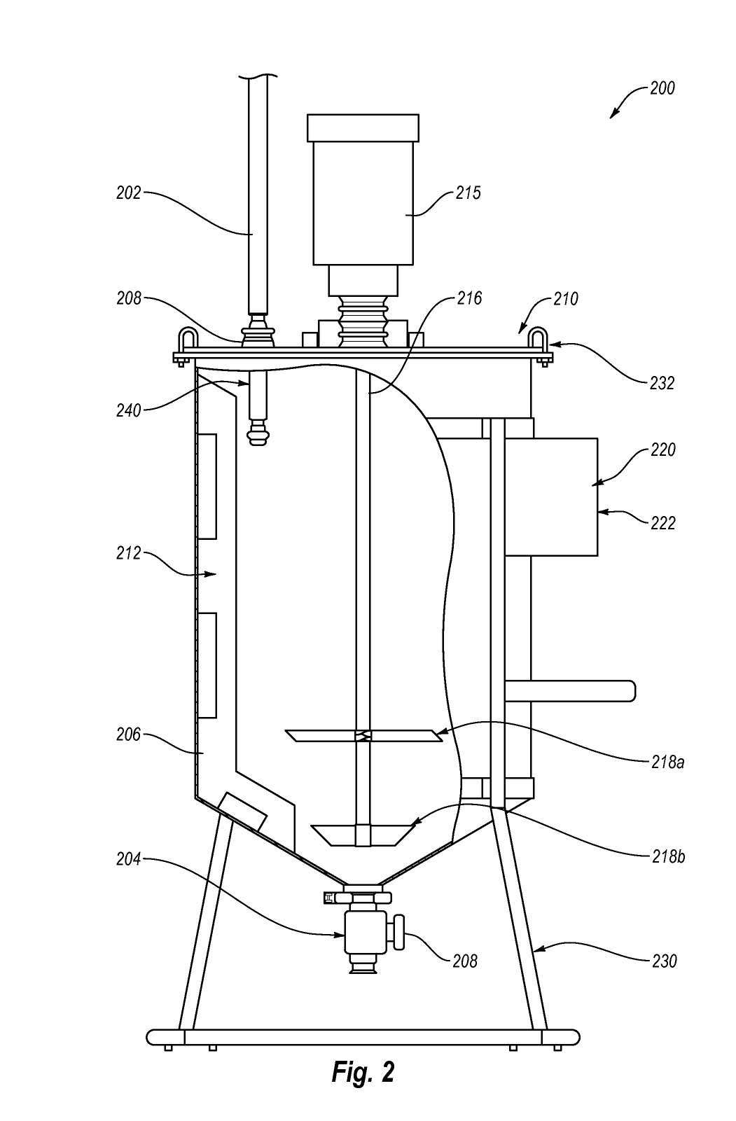

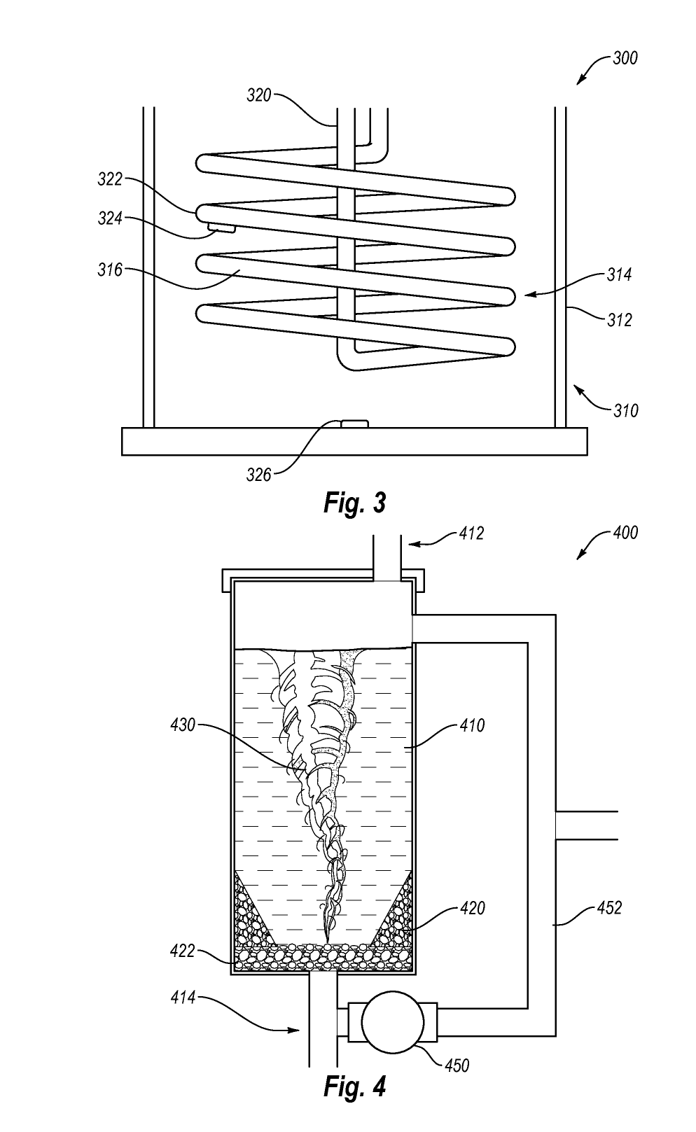

The water stabilization system 120 can be any system that can stabilize water in accordance with the principles described herein. The water stabilization system 120 can receive the filtered water and then stabilize the water with the ions described herein, such as alkaline ions, bicarbonate ions, magnesium ions, or stabilized with calcium hydroxide, magnesium hydroxide, sodium bicarbonate, and potassium bicarbonate. A water stabilization system 120 can include a water stabilization device 210 of FIG. 2, or other similarly configured mixing or dosing apparatus (e.g., Dosatron device). The water stabilization system 120 can provide the stabilized water to a water chilling system 130, which can be any system or one or more devices that can chill water to the temperatures described herein for chilled water (e.g., 4 degrees Celsius). The water chilling system 130 can include a water chiller 310 of FIG. 3, or other similarly configured chilling device. The water chilling system 130 can provide the chilled water to a water vortexing system 140, which includes a vortexing vessel 410 (see FIG. 4) that includes lodestones 420, and optionally includes other stones 422.

FIG. 1B illustrates another embodiment of a water revitalization system 100b in accordance with the present invention. This water revitalization system 100b includes a water chilling and vortexing system 135, which includes the components of the water chilling system 130 and water vortexing system 140. The components can be combined so that the water chilling and vortexing system 135 chills and vortexes the water in a single unit.

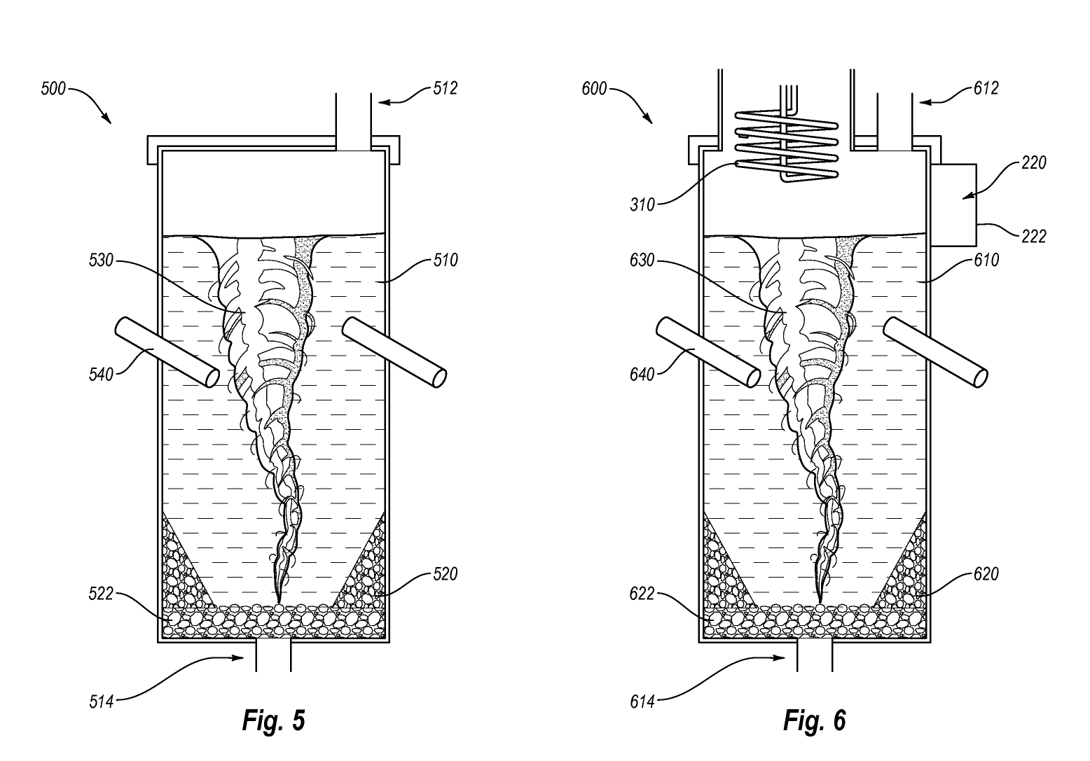

FIG. 1C illustrates another embodiment of a water revitalization system 100c in accordance with the present invention. This water revitalization system 100c includes a water chilling and vortexing and aeration system 137, which includes the components of the water chilling system 130 and water vortexing system 140 in addition to components that can facilitate aeration. The components can be combined so that the water chilling and vortexing and aeration system 137 chills, vortexes, and aerates the water in a single unit. The components of an aeration system are shown in FIG. 5, which includes a vortexing vessel 510 having the aeration components.

FIG. 1D illustrates another embodiment of a water revitalization system 100d in accordance with the present invention. This water revitalization system 100d has a separate water chilling system 130 but combines the water vortexing and aeration components into a water vortexing and aeration system 145. The water vortexing and aeration system 145 can include the vortexing vessel 510 and aeration components as shown in FIG. 5.

FIG. 1E illustrates another embodiment of a water revitalization system 100e in accordance with the present invention. This water revitalization system 100e includes a water stabilization and chilling and vortexing and aeration system 125, which includes the components of the water stabilization system 120, water chilling system 130, and water vortexing system 140 in addition to components that can facilitate aeration. The components can be combined so that the water stabilization and chilling and vortexing and aeration system 125 stabilizes, chills, vortexes, and aerates the water in a single unit. The water stabilization and chilling and vortexing and aeration system 125 can be a combination of the individual systems thereof, or a single unit having the components to perform the water stabilization and chilling and vortexing and aeration function, which is shown in FIG. 6.

In one embodiment, the present invention relates to systems and method for stabilizing water (e.g., deionized water) with appropriate ions (e.g., calcium, magnesium, sodium, and potassium alkaline ions). The water can be stabilized by a process that provides the water with appropriate ions. The stabilized water with appropriate ions can reduce, inhibit, or stop the water from ionizing itself with carbon dioxide, which makes carbonic acid. As such, the stabilized water with appropriate ions can inhibit the water from producing carbonic acid, and thereby can inhibit acidification of water. This can also promote neutrality or alkalinity of water.

FIG. 2 illustrates an embodiment of a water stabilization system 200 having a water stabilization device 210 and a water stabilization composition 220. The water stabilization composition 220 can be any composition in accordance with the teachings provided herein for a composition that can be used to stabilize water. The water stabilization device 210 can be configured as a water stabilization mixer that mixes the water (e.g., filtered water) with the water stabilization composition 220. The water stabilization device 210 is shown to include a water inlet 202, water outlet 204 fluidly coupled with a vessel 206, where one or more valves 208 can be included to regulate water flow. The vessel 206 optionally includes baffles 212 for enhanced mixing. The vessel 206 optionally includes a motor 215 that drives a shaft 216 with mixing blades 218a, 218b. However, other mixing devices can be used. The water stabilization system 200 can have a support structure 230 that holds the vessel 206 for structural stability. The vessel 206 can be airtight and operated without any air therein. However, the vessel 206 can include a nonreactive gas, such as nitrogen or noble gas, to fill the headspace above the water. The vessel 206 includes a lid 232 that can be opened as desired or needed, such as for cleaning. The water inlet 202 can include a pre-filter 240 to pre-filter the water before stabilization. The water stabilization composition 220 can be included within a reservoir 222 that can selectively dose the water with the water stabilization composition 220. As such, the reservoir 222 can be airtight. While not shown, a valve can separate the vessel 206 from the reservoir 222, and the water stabilization composition 220 can be metered and selectively added to the water in specific and controlled amounts. The water obtained from the water outlet 204 can be tested or analyzed for water stabilization composition content and to determine whether or not the water is stabilized. A computing system (not shown) can then monitor the water at the water outlet 204 and determine whether more or less water stabilization composition 220 is needed to reach an optimal stabilized water composition. Any of the components of the water stabilization system 200 can be combined with the other components of the systems described herein.

The water stabilization system 200 can be any system that can stabilize water in accordance with the principles described herein. The water stabilization system 200 can receive the filtered water and then stabilize the water with the ions described herein, such as alkaline ions, bicarbonate ions, magnesium ions, or stabilized with calcium hydroxide, magnesium hydroxide, sodium bicarbonate, and potassium bicarbonate. A water stabilization system 120 can include a water stabilization device 210 of FIG. 2, or other similarly configured mixing or dosing apparatus (e.g., Dosatron device).

The water stabilization system can introduce a mineral blend of calcium carbonate, magnesium hydroxide, and sodium and potassium bicarbonates. In one aspect, the mineral blend can be injected from a chemical injector (e.g., Doseatron injector). In one aspect, the injector can be a vortexing mineral injector, which contains stones having the mineral blend. As such, the mineral blend can be injected into the water, which creates high biophoton, properly mineralized, and energized pristine water that contains four bicarbonate salts (i.e., calcium, magnesium, sodium, and potassium). Bicarbonate ions are negatively charged and can have a strong affinity for the calcium and magnesium hydroxide. This union creates calcium and magnesium bicarbonate salts, which can be found in liquid form.

FIG. 3 illustrates an embodiment of a water chilling system 300. The water chilling system 300 can include a water chiller 310 that is configured to chill water to a set or desired temperature. The water chiller 310 includes a chilling vessel 312 having a chilling medium 314 with a water passageway 316 passing therethrough to be chilled by the chilling medium. The water passageway can be configured with an inlet portion 320 providing the water to be chilled and an outlet portion 322 chilling the water. A temperature sensor 324 can monitor the temperature of the chilled water and operational parameters, such as temperature, residence time, flow rate, or the like and such can be modulated in order to provide the water chilled to the specified or desired temperature (e.g., 4 degrees Celsius). Another temperature sensor 326 can monitor the temperature of the chilling medium 314. The chilling medium 314 can be a liquid, gas, supercritical fluid, solid, or any other temperature transferring phase or substance. For example, metal that has a chilled temperature can be used as the chilling medium, or a refrigerated fluid can cool the metal. However, the water chilling system 130 can be configured as any active chilling system, and can provide temperatures of any common, industrial, scientific, cryogenic, or any other freezer or temperature reducing apparatus. Any mechanical temperature reducing devices can be included. The chilling system 130 can include a water chiller that is configured to chill the water to get water that is relatively denser than regular room temperature water. For example, water is at its densest state at 4 degrees Celsius. This can help rid the water of trauma recording and reprogram water molecules.

FIG. 4 illustrates an embodiment of a water vortexing system 400. The water vortexing system 400 can include a vessel 410 having an inlet 412 to receive water and an outlet 414 to provide vortexed water. The vessel 410 can include lodestones 420, and optionally includes other stone mixtures 422 as described herein. The vessel 410 can include any means of vortexing the water, which can include directional water jets that cycle the water in a swilling motion until a vortex 430 in the water is achieved or bottom suction as well as stirring or other vortex forming devices.

In one embodiment, the vessel 410 can have minerals and stones 422 that contain natural salts of potassium, sodium, calcium, and magnesium. The stones 422 can be located on the bottom of the vessel 410. A pump (not shown) can drain the water from the bottom of the vessel 410, creating a vortex 430 about the stones 422. As noted above, such vortex can incorporate the minerals and elements contained in the stones 422 into the water. The forms of potassium, sodium, calcium, and magnesium can be the same as recited herein.

Optionally, a mechanical recirculation pump 450 can be placed at the outlet 414 and connected to recirculation passageways 452 that provide the recirculated water to the top of the vessel 410. This can include the mechanical recirculation pump 450 providing suction at the bottom or outlet 414 of the vessel 410 to produce a vortex 430 in the water. By creating suction at the bottom of the vessel 410 and simultaneously forcing the water to spin with the recirculating water at the top of the tank, a vortex forms in the water.

The system can have one or more stones (e.g., igneous, sedimentary, and metamorphic rocks) containing minerals, the one or more stones being located in the vessel, which can be configured as a vortex energizing tank. Furthermore, the vortex tank can be configured to pass the chilled water over or through lodestones, crystals, and other igneous, sedimentary and metamorphic rocks, and forming a first properly charged bicarbonate water. Lodestones are natural magnets and they possess the same energy as the telluric currents (e.g., earth currents) in the earth—magneto-electric. Lodestones in conjunction with crystals and igneous rock positively charge protons, negatively charge electrons, and magnetize hydrogen and neutrons to produce high biophoton pristine water.

Biophotons are photons of light (e.g., energy) emitted from a biological system. For living organisms, the key reference point on the biophoton energy scale is bound at 6,500 biophoton energy units. From 0 to 6,500 biophoton, the charge is in the negative range, or life-detracting, while above the 6,500 biophoton point, the energy gradually becomes more positive, or life-enhancing. Water chilled (to make it denser) and vortexed over lodestones (DC telluric currents from the earth), crystals, and other igneous, sedimentary, and metamorphic rocks in accordance with the processes of the invention can be reprogrammed or revitalized into high biophoton water (e.g., over 6,500) This will reduce the low energy and negative information that inundates the body from typical water. Telluric currents, bicarbonate ions, minerals, and biophotons (natural light energy) interact to create pristine high-biophoton drinking water under the present invention.

FIG. 5 illustrates an embodiment of a water vortexing and aeration system 500. The water vortexing system 500 includes a vessel 510 having an inlet 512 to receive water and an outlet 514 to provide vortexed water. The vessel 510 can include lodestones 520, and optionally includes other stone mixtures 522. The vessel 510 can include any means of vortexing the water, which can include directional water jets that cycle the water in a swilling motion until a vortex 530 in the water is achieved or bottom suction as well as stirring or other vortex forming devices. The vessel 510 can include an aeration inlet 540 that lets the air into the vessel for oxygenation. The aeration inlet 540 can be oriented to facilitate vortexing.

In one embodiment, the vessel 510 is connected to a vacuum line (not shown) at the outlet 514 on a vortex pump (not shown). The vacuum line can be connected to an oxygen generator (not shown). The oxygen generator infuses primarily oxygen with trace amounts of carbon dioxide into the water, which can saturate the water with oxygen and trace amounts of carbon dioxide to create bicarbonate ions. If the bicarbonate ions in the water are insufficient, the system can turn on the carbonator and add additional carbon dioxide to the alkaline magnesium water and create bicarbonates.

FIG. 6 illustrates an embodiment of a water stabilization and chilling and vortexing and aeration system 600. The water vortexing system 600 includes a vessel 610 having an inlet 612 to receive water and an outlet 614 to provide vortexed water. The vessel 610 can include lodestones 620, and optionally includes other stone mixtures 622. The vessel 610 can include any means of vortexing the water, which can include directional water jets that cycle the water in a swilling motion until a vortex 630 in the water is achieved or bottom suction (e.g., via a pump at 614) as well as stirring or other vortex forming devices. The vessel 610 can include an aeration inlet 640 that lets the air into the vessel for oxygenation. The aeration inlet 640 can be oriented to facilitate vortexing. Also, a water stabilization composition 220 can be included within a reservoir 222 that can selectively dose the water in the vessel 610 with the water stabilization composition 220. Also, a water chiller 310 can be thermally coupled with the vessel 610.

Any features of the systems of FIGS. 1A-1E and FIGS. 2-6 can be combined as desired.

It is known that pure water (e.g., substantially H₂O) has a high potential for acquiring ions, which ions can be acquired from the environment surrounding the water. In layman terms, the water is “hungry” for ions. As such, the high potential results in water usually having ions, and vary rarely is pure water (e.g., substantially H₂O) found in nature. When pure water is exposed to air, the pure water will pull the carbon dioxide (i.e., CO₂) out of the air and into the water, which consequently results in acidification of the water by production of carbonic acid from the carbon dioxide. It has been found that water has a high potential for spontaneously acquiring ions from the environment, which ions can be both positive ions (e.g., cations) or negative ions (e.g., anions). Accordingly, any carbon dioxide in the atmosphere can be capable of being directly dissolved into water (e.g., pure or substantially pure H₂O), and the water and carbon dioxide can immediately react to form carbonic acid (i.e., H₂CO₃), which is a positive ion or cation. However, carbonic acid is stable at 4 degrees Celsius and does not dissociate, but when carbonic acid warms up, the carbonic acid dissociates a hydrogen ion (H+) and the result is water having a hydrogen (i.e., proton or H+) cation and a bicarbonate anion (HCO₃⁻). The equation for the reaction between water and carbon dioxide is: H₂O+CO₂<=>H₂CO₃<=>H+ and HCO₃⁻. It is desirous to inhibit the reaction between water and carbon dioxide in order to inhibit acidification of water. However, if the water does not have enough negative ions (e.g., calcium, magnesium, potassium, or sodium) contained therein, the water will continually and rapidly react with carbon dioxide to produce carbonic acid. It has been discovered that the carbonic acid does not dissociate into bicarbonates due to excess acids and the lack of metals (e.g., negative ions) to stabilize the bicarbonates. As such, the carbonic acid can persist in the water, which is highly unfavorable for a variety of reasons, such as the reasons provided herein. As such, stabilizing water against reacting with carbon dioxide and inhibiting formation of carbonic acid in water can be favorable.

In one embodiment, water can be stabilized with bicarbonate ions. The bicarbonate ions can combine with insoluble metals (i.e., calcium, magnesium, potassium, and sodium hydroxides) in the water to form a water-soluble metal bicarbonate solution. While the bicarbonate ions may be able to combine with insoluble metals outside of water, the water provides a suitable environment for the bicarbonate ions to combine with the insoluble metals to form an aqueous metal bicarbonate solution. The metal bicarbonate solution can remain in the water until the supply of bicarbonate salts is exhausted, and there is no further bicarbonate salts to combine with the insoluble metals. Additional bicarbonate can be added as needed to maintain the aqueous metal bicarbonate solution. However, the bicarbonate ions can self-ionize and combine with the insoluble metals until there is no more bicarbonate ions left for this combination process. Also, the bicarbonate ions can inhibit the water from self-ionizing and reacting with carbon dioxide, which can inhibit formation of carbonic acid and the acidification of water. Accordingly, water can be stabilized by being inoculated with bicarbonate ions.

In one embodiment, water is stabilized with metal ions (e.g., calcium, magnesium, potassium, or sodium ions). This can include water being stabilized with at least 25 PPM anions added to the water or a total of 25 PPM anions in the water. However, this parts per million can range from about 20 PPM to about 500 PPM, from about 30 PPM to about 400 PPM, from about 40 PPM to about 300 PPM, from about 50 PPM to about 200 PPM, from about 60 PPM to about 100 PPM, from about 70 PPM to about 80 PPM, which can be a broad range of parts per million. The parts per million can have a smaller range of from about 20 PPM to about 100 PPM, from about 25 PPM to about 80 PPM, from about 30 PPM to about 60 PPM, from about 35 PPM to about 50 PPM, from about 40 PPM to about 45 PPM. The metal ions can include bicarbonate ions. The bicarbonate ions can stabilize the water and inhibit the water from reacting with carbon dioxide, and thereby inhibit the formation of carbonic acid or water acidification.

In one embodiment, water is stabilized with calcium hydroxide, magnesium hydroxide, sodium bicarbonate, and potassium bicarbonate. This can include water being stabilized with at least 25 PPM calcium hydroxide, magnesium hydroxide, sodium bicarbonate, and potassium bicarbonate added to the water and/or a total of 25 PPM calcium hydroxide, magnesium hydroxide, sodium bicarbonate, and potassium bicarbonate in the water. However, this parts per million can range from about 20 PPM to about 500 PPM, from about 30 PPM to about 400 PPM, from about 40 PPM to about 300 PPM, from about 50 PPM to about 200 PPM, from about 60 PPM to about 100 PPM, from about 70 PPM to about 80 PPM, which can be a broad range of parts per million. The parts per million can have a smaller range of from about 20 PPM to about 100 PPM, from about 25 PPM to about 80 PPM, from about 30 PPM to about 60 PPM, from about 35 PPM to about 50 PPM, from about 40 PPM to about 45 PPM. The bicarbonate ions can stabilize the water and inhibit the water from reacting with carbon dioxide, and thereby inhibit the formation of carbonic acid or water acidification.

In one embodiment, water is stabilized with ions other than bicarbonate ions. This can include water being stabilized with at least 25 PPM ions added to the water and/or a total of 25 PPM anions in the water after stabilization. However, this parts per million can range from about 20 PPM to about 500 PPM, from about 30 PPM to about 400 PPM, from about 40 PPM to about 300 PPM, from about 50 PPM to about 200 PPM, from about 60 PPM to about 100 PPM, from about 70 PPM to about 80 PPM, which can be a broad range of parts per million. The parts per million can have a smaller range of from about 20 PPM to about 100 PPM, from about 25 PPM to about 80 PPM, from about 30 PPM to about 60 PPM, from about 35 PPM to about 50 PPM, from about 40 PPM to about 45 PPM. The ions can stabilize the water and inhibit the water from reacting with carbon dioxide, and thereby inhibit the formation of carbonic acid or water acidification. The ions can help maintain the water to be acid free, while the water is brewed to produce bicarbonate ions.

In one example, the water obtained from the filtration process described herein or in the incorporated patent application can be combined with the ions. As such, water that is obtained from the filtration unit can be run water through a Dosatron, which injects calcium hydroxide, magnesium hydroxide, sodium bicarbonate, and potassium bicarbonate into the filtered water in order to increase the ion parts per million. The anion parts per million can be increased to 25 PPM. However, this parts per million can range from about 20 PPM to about 500 PPM, from about 30 PPM to about 400 PPM, from about 40 PPM to about 300 PPM, from about 50 PPM to about 200 PPM, from about 60 PPM to about 100 PPM, from about 70 PPM to about 80 PPM, which can be a broad range of parts per million. The parts per million can have a smaller range of from about 20 PPM to about 100 PPM, from about 25 PPM to about 80 PPM, from about 30 PPM to about 60 PPM, from about 35 PPM to about 50 PPM, from about 40 PPM to about 45 PPM. The injection of calcium hydroxide, magnesium hydroxide, sodium bicarbonate, and potassium bicarbonate can be performed by addition and mixing as described. The injection of calcium hydroxide, magnesium hydroxide, sodium bicarbonate, and potassium bicarbonate can be performed before the filtered water contacts air or other gas having carbon dioxide. The water injected with calcium hydroxide, magnesium hydroxide, sodium bicarbonate, and potassium bicarbonate can inhibit the water from interacting with carbon dioxide and forming carbonic acid. As such, the injection of calcium hydroxide, magnesium hydroxide, sodium bicarbonate, and potassium bicarbonate into water can stop the water from self-ionizing and/or self-acidification.

In one embodiment, the present invention relates to systems and methods for stabilizing water (e.g., deionized water) with appropriate magnesium ions (e.g., magnesium oxide, carbonate and hydroxide, with Mg₂⁺). The water can be stabilized by a process that provides the water with favorable magnesium ions. The stabilized water with appropriate magnesium ions can reduce, inhibit, or stop the water from ionizing itself with carbon dioxide, which makes carbonic acid. As such, the stabilized water with appropriate magnesium ions can inhibit the water from producing carbonic acid, and thereby can inhibit acidification of water. This can also promote neutrality or alkalinity of water.

In one embodiment, water is stabilized with magnesium ions. This can include water being stabilized with at least 25 PPM magnesium anions added to the water and/or a total of 25 PPM magnesium anions being in the water after stabilization. However, this parts per million can range from about 20 PPM to about 500 PPM, from about 30 PPM to about 400 PPM, from about 40 PPM to about 300 PPM, from about 50 PPM to about 200 PPM, from about 60 PPM to about 100 PPM, from about 70 PPM to about 80 PPM, which can be a broad range of parts per million. The parts per million can have a smaller range of from about 20 PPM to about 100 PPM, from about 25 PPM to about 80 PPM, from about 30 PPM to about 60 PPM, from about 35 PPM to about 50 PPM, from about 40 PPM to about 45 PPM. The magnesium ions can include magnesium bicarbonate anions. The magnesium ions can stabilize the water and inhibit the water from reacting with carbon dioxide, and thereby inhibit the formation of carbonic acid or water acidification. The magnesium ions can help maintain the water to be acid free, while the water is brewed to produce bicarbonate ions.

In one example, the water obtained from the filtration process described herein or in the incorporated patent application can be combined with minerals. As such, water that is obtained from the filtration unit can be run water through a magnesium oxide cartridge or water filter housing having magnesium ions, which injects magnesium ions into the filtered water in order to increase the magnesium anion parts per million. The magnesium ion parts per million can be increased to 25 PPM. However, this parts per million can range from about 20 PPM to about 500 PPM, from about 30 PPM to about 400 PPM, from about 40 PPM to about 300 PPM, from about 50 PPM to about 200 PPM, from about 60 PPM to about 100 PPM, from about 70 PPM to about 80 PPM, which can be a broad range of parts per million. The parts per million can have a smaller range of from about 20 PPM to about 100 PPM, from about 25 PPM to about 80 PPM, from about 30 PPM to about 60 PPM, from about 35 PPM to about 50 PPM, from about 40 PPM to about 45 PPM. The injection of magnesium ions can be performed by addition and mixing as described. The injection of magnesium ions can be performed before the filtered water contacts air or other gas having carbon dioxide. The water injected with magnesium ions can inhibit the water from interacting with carbon dioxide and forming carbonic acid. As such, the injection of magnesium anions into water can stop the water from self-ionizing and/or self-acidification.

In one embodiment, the system includes a magnesium cartridge to add ions to the water so it will not readily ionize itself with carbon dioxide and create carbonic acid water. The magnesium cartridge can be configured to add magnesium ions to the water so it will not continually ionize itself with carbon dioxide, which creates carbonic acid. The magnesium cartridge can be configured to stabilize the water.

In one embodiment, the present invention relates to systems and method for brewing water. As used herein, “brewing water” refers to chilling and vortexing water, but does not refer to heating or boiling water. The water can be chilled down to about 0 to 10 degrees Celsius (e.g., still flowable water), from 1 to 8 degrees Celsius, from 2 to 6 degrees Celsius, or about 4 to 5 degrees Celsius. The vortexing can be clockwise vortexing at any rate that causes a vortex to occur, which can be obtained by clockwise or counterclockwise vortexing about an axis. In one aspect, it can be counterclockwise. In another aspect, it can be clockwise. The vortex can be in either or both clockwise and counterclockwise. The vortexing can be performed to emulate nature during the brewing of the water. The brewing of the water can be over lodestones. A lodestone can be characterized by any of a variety of magnetite that possesses magnetic polarity and attracts iron, which lodestone can serve as a magnet for brewing water. The lodestone can be natural magnets and provide a source of pulsed field DC currents (e.g., from geological physics) during the brewing process.

The water can be brewed in order to reprogram the water to a healthier state. The water that is brewed can be alkaline water and/or acid-free water. The water that is brewed can be the water that is stabilized with anions, alkaline ions, magnesium ions, and/or bicarbonate ions. Also, the water that is brewed can be stabilized with calcium hydroxide, magnesium hydroxide, sodium bicarbonate, and potassium bicarbonate as described herein.

For example, water in today's environments can become traumatized and the molecules in water can record such trauma in the kinetic motions of the atoms and arrangements. The trauma can occur from various interaction of water with the environment, as described herein. Brewing the water with chilling and vortexing can erase the trauma recorded in the water and reprogram the water. This provides revitalized water that is trauma-free. The revitalized water that is brewed can have enhanced surface tension that is increased over water with recorded trauma. Additionally, the revitalized water can have increased coherency of water molecules. The increased coherency of water molecules can provide better cohesion therebetween as well as improved consistency of the water composition. The water brewing technology of the present invention can chill and vortex acid-free alkaline water over lodestones to erase trauma recorded in the water, and to reprogram the water, which enhances surface tension and increases the coherency of water molecules.

It is thought that water has a certain type of memory, which is attributed to the dipolar nature of the water, and which means the overall polarity of the water molecule creates a region of positive charge and a region of negative charge. Once water receives trauma, the trauma is recorded in the water to have the region of positive charge and a region of negative charge in the water molecule. Such trauma needs to be removed so that the water can be reprogrammed to remove the region of positive charge and a region of negative charge so that the water is overall neutralized. Water can become depleted of coherency as plants, animals, and other natural and manmade processes drain the life out of the water and induce trauma that is recorded. Brewing the water with chilling and vortexing can reprogram the water. Also, processing the water to be acid free and alkaline before brewing can improve the revitalization of water.

It is thought that most water that is consumed in today's environments can be classified as “lifeless,” due to a vast sum of contaminates and/or the lifeless water has not come into contact with the telluric currents of the earth. Most water that is consumed is acidic from acid rain, and it is hard from minerals. As such, this acidic hard water can lose beneficial molecular structures and have poor surface tension.

Also, when water is cooled to near freezing point, the presence of hydrogen bonds means that the water molecules, as they rearrange to minimize their energy, form a structure that is actually of lower density than flowable water. A strong hydrogen bond gives water a high cohesiveness and, consequently, high surface tension. For example, a large body of fresh water that is frozen in winter can have the bulk of the water still liquid at about 4 degrees Celsius beneath the icy surface. Accordingly, brewing can be conducted at about 4 degrees Celsius in order to revitalize the water.

In one embodiment, the brewing and revitalizing of water can include aerating the water. The aerating can be with air, substantially pure oxygen, and/or substantially pure carbon dioxide, which aerating can be by mixing in the presence of the gas (e.g., passive aeration) or injection of the gas into the water (e.g., active aeration). As such, the brewing and revitalizing of water can include chilling, aerating, and vortexing water over lodestone. The brewing and revitalizing water can include chilling, aerating, and vortexing water over lodestone, and over one or more of crystals, igneous, sedimentary, and metamorphic rocks, (e.g., certain select river rocks). This brewing and revitalizing of water is a synthetic or artificial process to revitalize water, which is configured to duplicate the natural process to erase trauma recording, reprogram the water, enhance surface tension, and increase the coherency of water molecules and create alkaline drinking water. As such, the brewing and revitalizing can erase trauma recording, reprogram the water, enhance surface tension, and increase the coherency of water molecules and create alkaline drinking water.

In one aspect, the water can be chilled by any process or mechanism that reduces the water to the appropriate temperature of chilled water, such as about 4 degrees Celsius. In one example, mechanical chilling can be used which uses processes in common refrigeration and/or freezing equipment. In another example, absorption chilling can be used, which can include creating chilled baths around a vessel having the water so that the water absorbs the cold temperature (e.g., the heat is transferred out of the water into the chilled bath), where acetone and dry ice baths can be used, or having the water vessel in contact with liquid nitrogen. Other chilling processes can be used.

In one aspect, the vortexing can be by any mechanical equipment capable of making water vortex. A stirrer can be used to rotate the water in the same direction in order to induce vortexing. In one example, the vortexing can be accomplished with a mechanical recirculation pump, which includes suction at the bottom to produce a vortex in the water. By creating suction at the bottom of the vortex tank and simultaneously forcing the water to spin with the recirculating water at the top of the tank we create a vortex in the water.

In one aspect, the lodestone under the vortexed water acts as a natural magnet and source of direct current voltage. The lodestone provides a unique form of voltage, delivering optimal and relative amounts of pulsed field magnetism and pulsed direct current. When chilled water is run over lodestones, it will positively charge protons, negatively charge electrons, and magnetize neutrons and hydrogen. Molecular oscillations are highly complex oscillation patterns which are emitted by atoms and/or molecules, which can be controlled by the lodestone for reprogramming and revitalizing water so as to remove trauma from the water. For example, drinking water can be chilled, vortexed, and come in contact with the telluric currents to properly recharge and reprogram its molecules to provide the revitalized water.

In one embodiment, the lodestone is magnetite that has been struck by lightning. The lodestone struck by lightning becomes characterized as biophoton-magnetoelectric lodestone. This occurs naturally when certain types of crystal structures in magnetite are struck by the strong bioelectric current of lightning, which creates a magnetoelectric charge. Also, magnetite may become a lodestone is when the minerals are heated past a certain temperature and then cooled back down, which can be done naturally or by protocol.

In one embodiment, the water brewing and revitalization protocol uses about 2 ounces of lodestone for 2 gallons of water. The vessel having the lodestones with the water vortexed thereover can be batch or continuous in operation. Any of the systems or vessels described herein can be batch or continuous in operation. When continuous, the flow can be a rate of 3 gallons per minute in order to revitalize 2 gallons of water being vortexed over the 2 ounces of lodestone. These parameters can be increased by using more lodestones to vortex and revitalize more water. A larger vortexing vessel may include up to as much as 50 pounds of lodestones in a 300-gallon tank, with a flow rate of 25 gallons per minute. These values can be used to interpolate for particular amounts of lodestones, vortexing quantities, and flow rates for revitalizing water in accordance with the present invention. Flow rates vary with different brewing capacity configurations and do not affect the brewing process. Lodestones can be placed in a number of locations (e.g., depending on the configuration), which can include the bottom of the vortexing vessel, or in discrete locations in the sides thereof. The water should constantly pass over the lodestone as the water circulates in the brewing process during vortexing.

It is known that lodestones vary in gauss (magnetism). The gauss of the earth is approximately 0.05. Accordingly, the lodestones used in the present invention can have substantially more natural magnetism than the earth. For example, the lodestones can have approximately 2.5 gauss. The lodestones can have a range of approximately 0.5 to 3.5 gauss, 1 to 3 gauss, 2 to 2.75 gauss, or about 2.5 gauss. In one example, the magnetoelectricity in the lodestone can have at least about 0.5 volts of pulsed field DC. The magnetoelectricity of the lodestones can vary from about 0.2 to about 1, from about 0.3 to about 0.9, or from about 0.5 to about 0.8, or from about 0.6 to about 0.7 volts of pulsed field DC For comparative purposes, the magnetoelectricity of the earth is less than 0.2 volts of pulsed field DC magnetricity.

In one aspect, the water can be brewed and revitalized by vortexing chilled water over lodestones for various times. In fact, the brewing and revitalizing can occur for a long duration. However, it has been found that water can be brewed and revitalized in less than 5 minutes while vortexing chilled water and recirculating the water over lodestones to erase trauma recording of the water and reprogram the water to produce revitalized water. For example, the brewing and revitalizing can be for less than 30 minutes, less than 20 minutes, less than 10 minutes, less than 5 minutes, or as low as 1-2 minutes.

In one embodiment, the present invention relates to systems and methods for stabilizing water (e.g., deionized water) with appropriate ions (e.g., alkaline ions) prior to brewing and revitalizing the water. The brewing and revitalizing can include vortexing chilled water over lodestones as described herein. Also, the brewing and revitalizing can include vortexing chilled water over lodestones and other river rocks (e.g., sedimentary, igneous, and/or metamorphic rocks) as described herein. Accordingly, the features of brewing and revitalizing water described herein can be combined and performed with stabilized water that is stabilized with appropriate ions. The water can be stabilized by a process that provides the water with appropriate ions, and then brewed by vortexing chilled water over lodestones. The stabilized water with appropriate ions can reduce, inhibit, or stop the water from ionizing itself with carbon dioxide, which makes carbonic acid. As such, the stabilized water with appropriate ions can inhibit the water from producing carbonic acid, and thereby can inhibit acidification of water. This can also promote neutrality or alkalinity of water.

The chilled water that is vortexed over lodestones can be stabilized with calcium hydroxide, magnesium hydroxide, sodium bicarbonate, and potassium bicarbonate. This can include water being stabilized with at least 25 PPM calcium hydroxide, magnesium hydroxide, sodium bicarbonate, and potassium bicarbonate added to the water and/or a total of 25 PPM calcium hydroxide, magnesium hydroxide, sodium bicarbonate, and potassium bicarbonate in the water. However, this parts per million can range from about 20 PPM to about 500 PPM, from about 30 PPM to about 400 PPM, from about 40 PPM to about 300 PPM, from about 50 PPM to about 200 PPM, from about 60 PPM to about 100 PPM, from about 70 PPM to about 80 PPM, which can be a broad range of parts per million. The parts per million can have a smaller range of from about 20 PPM to about 100 PPM, from about 25 PPM to about 80 PPM, from about 30 PPM to about 60 PPM, from about 35 PPM to about 50 PPM, from about 40 PPM to about 45 PPM. The bicarbonate anions can stabilize the water and inhibit the water from reacting with carbon dioxide, and thereby inhibit the formation of carbonic acid or water acidification. The stabilized water is then brewed by chilling the stabilized water and vortexing the stabilized water over lodestones as described herein. Alternatively, the water can be chilled and vortexed over lodestones while being stabilized, where the calcium hydroxide, magnesium hydroxide, sodium bicarbonate, and potassium bicarbonate is added during the vortexing. In one example, the filtered water is processed through a Dosatron to inject calcium hydroxide, magnesium hydroxide, sodium bicarbonate, and potassium bicarbonate into the water for stabilization before the filtered water contacts air, and then the stabilized water is brewed with contact to air or without contact to air. As such, the brewing can include aeration or exclude aeration.

In one embodiment, the present invention relates to systems and methods for stabilizing water (e.g., deionized water) with appropriate magnesium ions (e.g., magnesium anions or negatively charged magnesium ions) prior to brewing and revitalizing the water. The brewing and revitalizing can include vortexing chilled water over lodestones as described herein. Also, the brewing and revitalizing can include vortexing chilled water over lodestones and other rocks (e.g., sedimentary, igneous, and/or metamorphic rocks) as described herein. Accordingly, the features of brewing and revitalizing water described herein can be combined and performed with stabilized water that is stabilized with appropriate magnesium ions. The water can be stabilized by a process that provides the water with appropriate magnesium ions, and then brewed by vortexing chilled water over lodestones. The stabilized water with appropriate ions can reduce, inhibit, or stop the water from ionizing itself with carbon dioxide, which makes carbonic acid. As such, the stabilized water with appropriate ions can inhibit the water from producing carbonic acid, and thereby can inhibit acidification of water. This can also promote neutrality or alkalinity of water.

Accordingly, the chilled water that is brewed by vortexing over lodestones is stabilized with magnesium ions (e.g., magnesium carbonate and hydroxide). This can include water being stabilized with at least 25 PPM magnesium ions added to the water and/or a total of 25 PPM magnesium ions being in the water to stabilize the water. However, this parts per million can range from about 20 PPM to about 500 PPM, from about 30 PPM to about 400 PPM, from about 40 PPM to about 300 PPM, from about 50 PPM to about 200 PPM, from about 60 PPM to about 100 PPM, from about 70 PPM to about 80 PPM, which can be a broad range of parts per million. The parts per million can have a smaller range of from about 20 PPM to about 100 PPM, from about 25 PPM to about 80 PPM, from about 30 PPM to about 60 PPM, from about 35 PPM to about 50 PPM, from about 40 PPM to about 45 PPM. The magnesium anions can include bicarbonate anions. The magnesium anions can stabilize the water and inhibit the water from reacting with carbon dioxide, and thereby inhibit the formation of carbonic acid or water acidification. The magnesium anions can help maintain the water to be acid free, while the water is brewed to produce bicarbonate ions. For example, water that is obtained from the filtration unit can be run water through a magnesium oxide cartridge or water filter housing having magnesium ions (e.g., magnesium anions), which injects magnesium ions into the filtered water in order to increase the magnesium anion parts per million, and then the water is chilled and vortexed over loadstones to increase the magnesium ion parts per million in accordance with the magnesium ion parts per million described herein. In one example, the filtered water is processed through a magnesium oxide cartridge or water filter housing having magnesium ions (e.g., magnesium anions) to inject magnesium ions into the water for stabilization before the filtered water contacts air, and then the stabilized water is brewed with contact to air or without contact to air. As such, the brewing can include aeration or exclude aeration.

In one embodiment, the present invention relates to systems and methods for stabilizing water (e.g., deionized water) with appropriate magnesium ions (e.g., magnesium anions or negatively charged magnesium ions) and brewing and revitalizing the water with aeration. The brewing and revitalizing can include vortexing chilled water over lodestones as described herein. The water can be stabilized acid-free magnesium water. The aerating and brewing the chilled vortexed water (e.g., over lodestones) can stabilize acid-free magnesium water with air which contains carbon dioxide, which creates carbonic acid in the alkaline water, which dissociates into bicarbonate ions to create magnesium bicarbonate. This also oxygenates the stabilized acid-free magnesium water.

Also, the brewing and revitalizing can include aerating and vortexing chilled water over lodestones and other rocks (e.g., sedimentary, igneous, and/or metamorphic rocks) as described herein. Accordingly, the features of brewing and revitalizing water described herein can be combined and performed with stabilized water that is stabilized with appropriate magnesium ions. The water can be stabilized by a process that provides the water with appropriate magnesium ions, and then brewed by aerating and vortexing chilled water over lodestones. The stabilized acid-free magnesium water can be considered the water that is stabilized with the magnesium ions as described herein, and such magnesium water is aerating and vortexed over lodestones while chilled.

As described and obtained by the processes of the invention, oxygenated water is considered water that has had additional oxygen introduced into it under pressure. Air is commonly 78% nitrogen, 21% oxygen, and 1% other gasses. The oxygenated water can be obtained by running air through an oxygen generator, which removes the nitrogen from the air to produce oxygenated air having about 98% oxygen and 2% other gasses. Portable oxygen generators can produce from 1 to 10 liters oxygenated air per minute. Most water is fully oxygen-saturated within 20 minutes with 1 liter per minute. In one aspect, the process can use a vacuum line to introduce the oxygen and other gasses (e.g., oxygenated air) into the recirculation line during vortexing. The oxygenated air contains the carbon dioxide which is necessary to create carbonic acid in the water, which dissociates into bicarbonate ions. The bicarbonate ions stabilize themselves with magnesium, which creates magnesium bicarbonate. The vortexing water also allows oxygen to be easily absorbed into the water molecules. As the fine oxygenated air bubbles rise to the surface, they push gasses from the water, which process is known as “air sparging.” This aerobic or oxygenated environment discourages and neutralizes the growth of pathogens in water, which are generally anaerobic. Bacteria, viruses, and other pathogenic organisms will not flourish in an oxygenated environment of the aerated and brewed stabilized acid-free magnesium water.

In one example, a smaller scale water brewing system can be operated with a unique methodology. As such, tap water can be loaded with air, which results in the water coming out of the processing system (e.g., out of a PristineHydro Living Water Unit) is almost white, as the air (e.g., 78% nitrogen, 21% oxygen, and 1% other gasses) is forced through the RO membrane (e.g., prior to the deionization cartridge, which removes the acids, which can remove acid rain) and creates millions of small bubbles of air which oxygenates the water. The water clears up substantially immediately after it comes out of the processing system; however, clearing of the water may occur in a minute or two. This process can utilize air sparging.

It is thought that while the chemical property of water is H₂O, the oxygen content in the water is also a physical property of water, just as pH, temperature, and purity are physical properties of water. It is also thought that a human body cannot get oxygen through water because H₂O is bound tightly with hydrogen bonds, which are very strong. The hydrogen bonds of water are what allow water to not boil until it reaches a very high temperature (e.g., 100 degrees Celsius). Because of this strength of hydrogen bonds, a human body does not have enough heat to break apart the bonds and produce oxygen. In order for a human body to use oxygen it has to have tiny areas where oxygen exchange can occur between the blood and air. These spaces are called alveoli, and they are found only within lungs. Accordingly, the present invention can include using oxygen to improve the quality of water, which helps degas the water. It also prevents bacteria, viruses, and other pathogenic organisms from proliferating in a non-oxygenated environment.

In one embodiment, the present invention relates to systems and methods for stabilizing water (e.g., deionized water) with calcium hydroxide, magnesium hydroxide, sodium bicarbonate, and potassium bicarbonate, and brewing and revitalizing the water with aeration. That is, the vortexing of chilled water over lodestones is performed with aeration and using water stabilized with calcium hydroxide, magnesium hydroxide, sodium bicarbonate, and potassium bicarbonate. This can include water brewing by vortexing chilled acid-free water that contains calcium hydroxide, magnesium hydroxide, sodium bicarbonate, and potassium bicarbonate with air, which contains carbon dioxide, which creates carbonic acid in the alkaline water, which dissociates into bicarbonate ions to create calcium and magnesium bicarbonate. It also oxygenates the stabilized water. Accordingly, the aeration and brewing process described herein with stabilized acid-free magnesium water can be performed with water that is stabilized with calcium hydroxide, magnesium hydroxide, sodium bicarbonate, and potassium bicarbonate, where other protocols are maintained. The stabilized water can have similar properties because it is stabilized and oxygenated, and thereby may be anti-microbial or at least inhibit microbial growth. The stabilized water can have calcium and magnesium bicarbonate, and can be referred to as stabilized acid-free calcium and magnesium water.

In one embodiment, the present invention can include preparing a composition with electrolyte balance (e.g., ElectrolyteBalance™). The composition with electrolyte balance can have sodium bicarbonate, potassium bicarbonate, calcium bicarbonate, magnesium bicarbonate, magnesium hydroxide and/or calcium hydroxide. In one aspect, the composition with electrolyte balance can include sodium bicarbonate, potassium bicarbonate, calcium bicarbonate, and magnesium bicarbonate. Optionally, the magnesium hydroxide and/or calcium hydroxide can be added. The composition with electrolyte balance can have sodium bicarbonate, potassium bicarbonate, calcium bicarbonate, and magnesium bicarbonate introduced to water to increase the parts per million in accordance with the parts per million ranges described herein. Also, the composition with electrolyte balance can increase the buffering capacity of the water or aqueous composition prepared therefrom. The composition with electrolyte balance can facilitate neutralization of excess acids in the body.

In one embodiment, a composition with electrolyte balance can be used for stabilization. The composition with electrolyte balance can stabilize the water, which allows the pancreas to balance (e.g., store and secrete ions) the internal pH of the body. The composition with electrolyte balance can be about 85% magnesium bicarbonate, 5% calcium bicarbonate, 5% potassium bicarbonate, and 5% sodium bicarbonate. These values can range from +/10%, 5%, 2%, or 1%. The composition with electrolyte balance provides bio-available bicarbonate electrolyte salts. The benefits of the composition with electrolyte balance are as follows: replenishes severe magnesium bicarbonate deficiency; facilitates calcium, potassium, and sodium voltage gated ion channels that allow magneto-electrical signaling in neurons and other excitable cells; treating magnesium bicarbonate deficiency to increase memory, focus, and/or deep relaxation; the magnesium bicarbonate can protect cells from heavy metal poisoning, such as from inorganic aluminum, mercury, lead, nickel, cadmium, fluoride, etc., or from noxious chemicals and radiation exposure; magnesium bicarbonate can reduce insomnia, headaches, and inflammation in the body; and/or magnesium bicarbonate can increase life span up to 30%, which increase in life span is due to low carbon dioxide concentrations in the body's intracellular waters. The composition with electrolyte balance can buffer the excess bad acids out of the body and allow the pancreas to balance (e.g., store and secrete ions) pH.

The revitalized water obtained with the processes herein, which include the magnesium, can provide a body proper balance of mineral content. The revitalized water can provide a healthy balance (“homeostasis”) of important minerals such as calcium and sodium and potassium bicarbonate, which are involved in the conduction of nerve impulses, muscle contraction, and heart rhythms.

The revitalized water can be used for maintaining or repairing sodium-potassium pumps. Magnesium deficiency impairs the sodium-potassium pump, allowing potassium to escape from the cell, to be lost in the urine, potentially leading to potassium deficiency (hypokalemia). Those with a known potassium deficiency, therefore, often do not respond to treatment until magnesium deficiency is also corrected. Accordingly, the revitalized water can be used for treating potassium deficiency and/or magnesium deficiency.

In one embodiment, the revitalized water and/or the composition with electrolyte balance can be used to promote a healthy lifestyle. This can include consuming the revitalized water and/or the composition with electrolyte balance, such as in-between meals, at breaks, throughout the day, before bed, and/or first thing in the morning. Also, the consumption of revitalized water and/or the composition with electrolyte balance can be coupled with eating more alkaline-friendly foods to promote a healthy lifestyle.

The revitalized water and/or the composition with electrolyte balance can be used to treat metabolic acidosis, as well as ailments or disease conditions associated therewith, such as those described herein. Metabolic acidosis can cause a person to retain more fluoride than individuals with a balanced pH. The more acidic the body, the less excretion of fluoride. Retained fluoride will be chemically bound in different organs, principally in the hard tissues of the body, primarily the teeth and bones.

The revitalized water and/or the composition with electrolyte balance can contain laboratory-grade alkalizing bicarbonate salts that will help buffer excess acids that overwhelm the pancreas, which allows the pancreas to recover its bicarbonate reserves and balance physiological pH. This can promote the body for self-healing.

In view of the foregoing, water can be stabilized and revitalized by these processes and protocol in order to obtain the desired water product. Each protocol has a nuance that contributes to the revitalized water product. The revitalized water products range from stabilized water to stabilized acid-free magnesium water and to stabilized acid-free calcium and magnesium water and others described herein. The processing of the water can be performed with equipment and/or systems and/or the U.S. patent application Ser. No. 13/712,581 filed Dec. 12, 2012, which is incorporated herein by specific reference. Also, the water obtained by processing with the invention of this patent application can be processed by the protocols described herein in order to obtain the water products.

In one embodiment, the present invention can provide an artificial or simulated hydrologic cycle and/or carbon cycle to process the water into a desired water product. This allows the water products produced in accordance with this invention to be considered pristine drinking water.

In one aspect, treating metabolic acidosis can treat a poorly-functioning kidney so as to: improve ability of the kidneys to excrete the metabolic acids, improve kidney generating sufficient bicarbonate, or inhibit excessive loss of bicarbonate via kidney or gastrointestinal tract.

In one aspect, treating metabolic acidosis can treat a poorly-functioning liver. The liver is important in acid-based physiology, and important as a metabolically-active organ which may be either a significant net producer or consumer of acids.

The revitalized water and/or the composition with electrolyte balance can be used to facilitate complete oxidation of carbohydrates and fat, which occurs in the liver, to produce carbon dioxide but no fixed acids. As the liver uses 20% of the body's oxygen consumption, this hepatic metabolism represents 20% of the body's carbon dioxide production. As the carbon dioxide diffuses out of the liver it helps sustain the carbonic acid/bicarbonate buffer system of the blood.

The revitalized water and/or the composition with electrolyte balance can be used to maintain or improve metabolism of various organic acids in the liver resulting in consumption of H+ and regeneration of the extracellular bicarbonate.

The revitalized water and/or the composition with electrolyte balance can be used to maintain or improve metabolism of ammonium to urea (a weak base). Human bodies cannot tolerate high concentrations of urea. However, it is less toxic than ammonia and urea is removed efficiently by the kidneys.

The revitalized water and/or the composition with electrolyte balance can be used to maintain or improve production of plasma proteins. Plasma protein has several functions in the human body, making it an important component of the fluid that carries red blood cells, platelets and white blood cells. Proteins contribute to healthy skin and hair, help the body produce energy and assist in the production of hormones and enzymes.

The revitalized water and/or the composition with electrolyte balance can be used to maintain blood pH. Human blood pH has a very narrow range of around 7.35 to 7.45. If human blood pH deviates from this range, the person can be sick or have symptoms of falling sick. If the pH falls below 6.8 or above 7.8, human body cells can stop functioning and death will occur.

The revitalized water and/or the composition with electrolyte balance can be used to treat the pancreas. Bicarbonate generation is stimulated by a high-protein diet and exercise. However, metabolic acidosis (e.g., acute or chronic) can overwhelm the pancreas' ability to operate effectively. With excess acids in the body the pancreas cannot store or secrete enough bicarbonate to neutralize the acids and balance pH. Without sufficient bicarbonate reserves, the pancreas is slowly destroyed and the body is not able to maintain its normal pH levels. The body is now forced to pull calcium, magnesium, potassium, and sodium from the bones to counteract the acids and keep the pH of our blood in check. If this process is not sufficient, the liver goes into ammonia cycle to neutralize the acids. Accordingly, the revitalized water and/or the composition with electrolyte balance can be used to alleviate these problems.

The revitalized water and/or the composition with electrolyte balance can be used to inhibit or treat problems associated with acute metabolic acidosis, which affects a number of organ systems, such as the cardiovascular system. Adverse effects of acute metabolic acidosis can include decreased cardiac output, arterial dilatation with hypotension, altered oxygen delivery, decreased ATP production, predisposition to arrhythmias, and impairment of the immune response. Mental confusion and lethargy are often observed in patients with acute metabolic acidosis, despite minor changes in cerebrospinal and brain pH. Lymphocyte function is suppressed with acute metabolic acidosis, leading to increased inflammation and an impaired immune response.

The revitalized water and/or the composition with electrolyte balance can be used to inhibit or treat problems associated with chronic metabolic acidosis. The main adverse effects of chronic metabolic acidosis are increased muscle degradation and abnormal bone metabolism, as well as indirect effects on these tissues emanating from alterations in the secretion and/or action of several hormones. These abnormalities are more frequent and severe with greater degrees of metabolic acidosis, but even mild metabolic acidosis contributes to the development of bone disease and muscle degradation. Cellular energy production is compromised with chronic metabolic acidosis. In addition, the cellular response to insulin can be impaired with chronic metabolic acidosis, partly as a result of a pH-dependent decrease in the binding of insulin to its receptor, which plays a role in type 2 diabetes. Metabolic acidosis can also cause brain damage and cerebral palsy in newborns.

The revitalized water and/or the composition with electrolyte balance can be used to provide calcium, magnesium, potassium, and sodium bicarbonates to a body. When calcium, magnesium, potassium, and sodium bicarbonates are supplemented in the body, they buffer excess acids, which allows the pancreas to store bicarbonate. The pancreas can be provided with sufficient reserves to secrete bicarbonate when needed and keep our pH balanced.

The revitalized water and/or the composition with electrolyte balance can be used to treat magnesium deficiency and treat or inhibit problems associated therewith as well as provide magnesium. When a body has magnesium deficiency, inorganic calcium builds up in the cells causing angina, arrhythmia, hypertension, headaches, and asthma. Magnesium is an inorganic calcium channel blocker. Magnesium is also a potassium antagonist. Magnesium is our defense from inorganic calcium and potassium poisoning. Magnesium is one of the most common co-factors in the body. Its presence is crucial to: glucose and fat breakdown; production of proteins, enzymes, and antioxidants such as glutathione; creation of DNA and RNA; and regulation of cholesterol production. The benefits of magnesium include the well-known decrease in ischemic heart disease and sudden death, prevention of platelet clumping (clot prevention), dilation of blood vessels, and improves the functioning of the heart muscle. Magnesium calms the nerves. Magnesium mediates digestive processes. A lack of it is associated with many eating-related problems, including vomiting, indigestion, cramps, flatulence, abdominal pain, and constipation. When under stress, we use up much magnesium. Magnesium deficiency has been implicated in depression, diabetes, heart disease, migraines, and menopausal symptoms.

The revitalized water and/or the composition with electrolyte balance can be used to treat, inhibit, or prevent metabolic acidosis and a magnesium deficiency. Thus, it can treat, inhibit, or prevent: cancer, arthritis, decreased bone density, diabetes, heart disease, chronic fatigue, allergies, dry skin, weight gain or inability to lose weight, depression, inability to concentrate or focus, being prone to colds and bronchitis, parasites infection, fungus infection, Candida infection, kidney stones, trouble with sleep patterns, or other. When magnesium bicarbonate enters body cells, the concentrations of bicarbonate ions inside body cells are increased. The bicarbonate derived from magnesium bicarbonate produces hydroxide ions (OH−) inside body cells, which neutralize the acid (H+) from carbon dioxide concentrations, ATP hydrolysis, and other sources. This occurs via a series of sequential and simultaneous reactions. Magnesium bicarbonate enters body cells and dissociates to increase bicarbonate ion concentrations inside body cells. Magnesium bicarbonate assists in the maintenance of cell homeostasis.

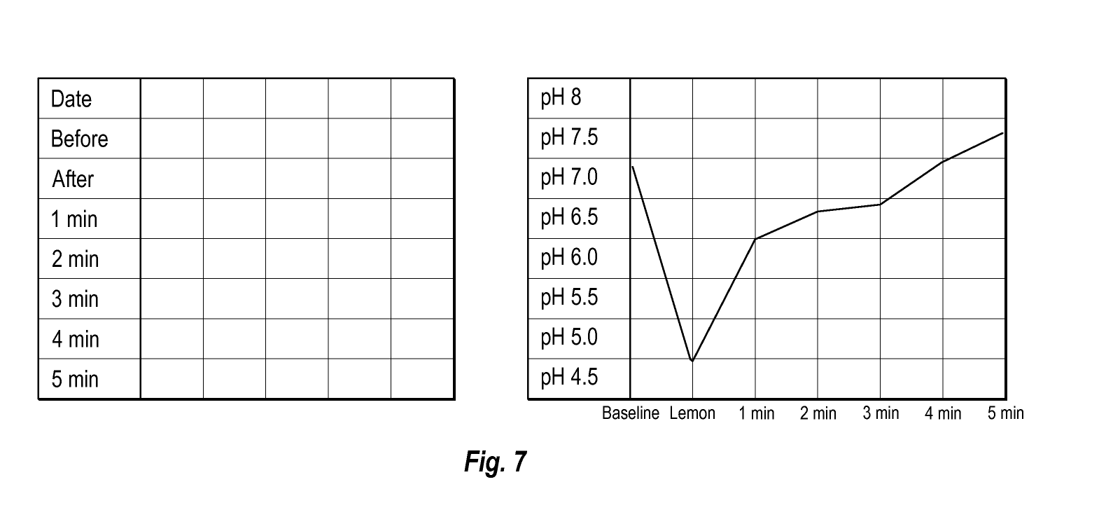

In one embodiment, the present invention provides a method of monitoring bicarbonate mineral reserves to see if the pancreas has the ability to keep pH balanced. The method can be performed after not drinking or eating anything for two hours (approximately) prior to taking the test. The best time to perform the method is first thing in the morning. The method includes: tear off seven strips of pH paper, each about 2″ long, optionally, set on tissue; measure out (and have ready in a cup) 1 tablespoon of lemon juice mixed with 1 tablespoon water; make a pool of saliva in mouth; dip 1 end of strip of pH paper into the pool and wet it (do not suck on strip—just wet it); remove and compare color immediately (strip will darken with time so compare immediately); place the pH paper against the pH scale provided and record the result as a baseline in the attached chart; quickly sip down the lemon juice mix in four sips (e.g., with a quick swish with each sip); as soon as the whole mix is swallowed, test pH again and record (in the lemon column in the chart of FIG. 7), and also start timer; for the next five minutes, one minute apart, test the saliva with the last five pH strips, and record each reading on the attached chart; after finished recording results, put a mark for each result on the appropriate location on the graph, draw a line, and connect the dots. The results can be compared for different tests and to the graph of FIG. 7. The graph of FIG. 7 shows a proper pH response to lemon challenge test. The test can be repeated, as many as five times, and compared to the chart. If the pH is not able to be balanced, the revitalized water and/or the composition with electrolyte balance can be used help balance the pH. If the pancreas can secrete enough bicarbonate to handle the acid, the pH will correspond proportionately with the chart. However, if the pH does not drop down to 4.5, then acute metabolic acidosis may be present or chronic metabolic alkalosis may be present. Both can be treated with the revitalized water and/or the composition with electrolyte balance.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally-equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes, but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third, and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims. All references recited herein are incorporated herein by specific reference in their entirety.

1. A method of inhibiting water from ionizing and reacting with carbon dioxide, the method comprising:
providing processed water having a potential for reacting H₂O with CO₂ in a system substantially devoid of O₂ and/or CO₂;
providing at least about 20 PPM of negative ions to the H₂O in a sufficient amount to react therein in the system substantially devoid of O₂ and/or CO₂; and
inhibiting the H₂O from reacting with CO₂ to form carbonic acid by reacting the H₂O with the negative ions in a sufficient amount in the system substantially devoid of O₂ and/or CO₂ so as to stabilize the processed water to form stabilized water.

2. The method of claim 1, wherein the processed water is processed to be acid free and/or deionized water.

3. The method of claim 2, wherein the negative ions are of calcium, magnesium, potassium, or sodium.

4. The method of claim 3, wherein the negative ions include bicarbonate ions and/or hydroxide ions.

5. The method of claim 4, wherein the bicarbonate ions and/or hydroxide ions combine with insoluble metals of hydroxides of calcium, magnesium, potassium, or sodium in the processed water to form water-soluble metal bicarbonates amount in the system substantially devoid of O₂ and/or CO₂.

6. The method of claim 5, wherein the water-soluble metal bicarbonates are retained in a solution with a sufficient amount of bicarbonate salts, the bicarbonate salts being sufficient for self-ionization.

7. The method of claim 4, wherein the negative ions are of calcium hydroxide, magnesium hydroxide, potassium bicarbonate, or sodium bicarbonate, which are provided in a sufficient amount to inhibit formation of carbonic acid.

8. The method of claim 4, comprising exposing the H₂O to O₂ and/or CO₂, wherein the H₂O is inhibited from reacting with the CO₂ to form carbonic acid.

9. The method of claim 8, comprising maintaining the pH of the processed water with a sufficient amount of the negative ions.

10. The method of claim 3, wherein the negative ions are magnesium ions.

11. The method of claim 3, comprising:
obtaining the stabilized water; and
chilling the stabilized water to about 4 degrees Celsius.

12. The method of claim 11, comprising:
obtaining the chilled water; and
vortexing the chilled water over lodestones.

13. The method of claim 12, wherein the vortexing is sufficient to increase coherency and/or surface tension of the chilled water compared to coherency and/or surface tension before chilling and vortexing.

14. The method of claim 13, comprising vortexing and aerating, simultaneously, the chilled water over lodestones sufficient to increase coherency and/or surface tension of the chilled water compared to coherency and/or surface tension before vortexing and aerating.

15. The method of claim 14, wherein the vortexing and aerating is performed by a mechanical recirculation pump operably coupled to a vortexing vessel having the chilled water.

16. The method of claim 14, wherein the vortexing is as follows:
lodestone present from 1 ounce to 50 pounds;
flow rate for the chilled water of 3 gallons per minute to 25 gallons per minute; and
vortexing vessel having between 2 gallons and 300 gallons of the chilled water being vortexed and aerated.

17. The method of claim 16, wherein the air provided during the aerating is oxygenated air or de-nitrogenated.

18. The method of claim 15, wherein the air provided during the aeration is provided through a vacuum line fluidly coupled with a recirculation line fluidly coupled with the mechanical recirculation pump.

19. The method of claim 14, comprising oxygenating and air sparging the chilled water being vortexed over lodestones.

20. The method of claim 19, comprising oxygenating and air sparging the chilled water being vortexed over lodestones to oxygenate the air sufficiently to inhibit microbe growth once the water is stored.
